(19) United States
(12) Patent Application Publication
(10) Pub. No.: US 2013/0127252 A1
(43) Pub. Date: May 23, 2013

(54) Wireless Energy Transfer with Perfect Magnetic Conductors

(71) Applicants: William S. Yerazunis, Acton, MA (US); Jing Wu, Boston, MA (US); Bingnan Wang, Boston, MA (US); Koon Hoo Teo, Lexington, MA (US)

(72) Inventors: William S. Yerazunis, Acton, MA (US); Jing Wu, Boston, MA (US); Bingnan Wang, Boston, MA (US); Koon Hoo Teo, Lexington, MA (US)

(21) Appl. No.: 13/298,828

(22) Filed: Nov. 17, 2011

(51) Int. Cl. H02J 17/00; H01F 38/14

(52) U.S. Cl. 307/104

(57) ABSTRACT

A system that transfers energy wirelessly includes a transmitter of the energy and a receiver of the energy. A housing made of a material that approximates properties of a perfect magnetic conductor. The housing is arranged to direct a magnetic field from the transmitter to the receiver to improve an efficiency of the energy transfer from the transmitter to the receiver.

### FIELD OF THE INVENTION

This invention relates generally to wireless energy transfer, and more particularly to transferring energy using perfect magnetic conductors.

### BACKGROUND OF THE INVENTION

Perfect magnetic conductors (PMCs) are a variant on the concept of metamaterials that has an extremely high permeability μ (mu), and an extremely high magnetic field saturation value. Like most metamaterials, PMCs do not occur naturally, but are realized artificially. For example, an approximate band-limited artificial PMC can be constructed by placing periodic elements such as square conductive patches with central conducting vias through an insulating substrate connecting to a conducting backplane, sometimes called the “mushroom array” configuration. The arrays can be modified by adding spirals, inductors, etc., to alter the frequency response. Unmodified, these PMCs typically have bandwidths of five to ten percent of their center frequency, which is entirely adequate for the purposes of wireless energy transfer.

An efficient PMC can be constructed from a grounded ferrite slab with an appropriate bias voltage. Electromagnetic band gap (EBG) materials can also be used for PMCs.

### SUMMARY OF THE INVENTION

The embodiments of the invention improve an efficiency of wireless energy transfer by using perfect magnetic conductors (PMCs) as reflectors and field confinement devices placed adjacent to transmit and receive antennas.

If the energy transfer system uses an array of resonators, it is possible to improve the energy transfer efficiency by arrange a layer of PMC as a reflective backing adjacent to the array.

The PMC provides partial confinement of the magnetic field and focuses the magnetic field in the direction from the receive antenna(s).

### BRIEF DESCRIPTION OF THE DRAWINGS

FIG. 1 is a schematic of a perfect magnetic conductor (PMC) in the presence of an electric current and associated magnetic field according to embodiments of the invention;

FIGS. 2-4 are oblique exploded, oblique assembled and side cross-sectional schematic views of a wireless energy transfer device using PMC according to embodiments of the invention;

FIG. 5 is a cross-sectional schematic view of a wireless energy transfer using PMC according to embodiments of the invention;

FIG. 6 is an oblique schematic view of a wireless energy transfer array according to embodiments of the invention; and

FIG. 7 is a sectional schematic view of a wireless energy transfer array according to embodiments of the invention.

### DETAILED DESCRIPTION OF THE PREFERRED EMBODIMENTS

The embodiments of our invention improve an efficiency of wireless energy transfer by using perfect magnetic conductors (PMCs) as reflectors and field confinement devices placed adjacent to transmit and receive antennas.

In one embodiment, a transmit loop and a transmit resonator are arranged in a housing made of the PMC, with an open side of the housing facing a receive loop, and a receive resonator. The resonator is not required, but can improve the efficiency of the energy transfer.

For an array of resonators, the PMC is arranged as a flat underlay layer below the array of resonators. The effect of this arrangement is that the energy transfer efficiency is greatly increased, (to a first approximation efficiency is doubled, and losses are halved) and the energy distribution is more uniform.

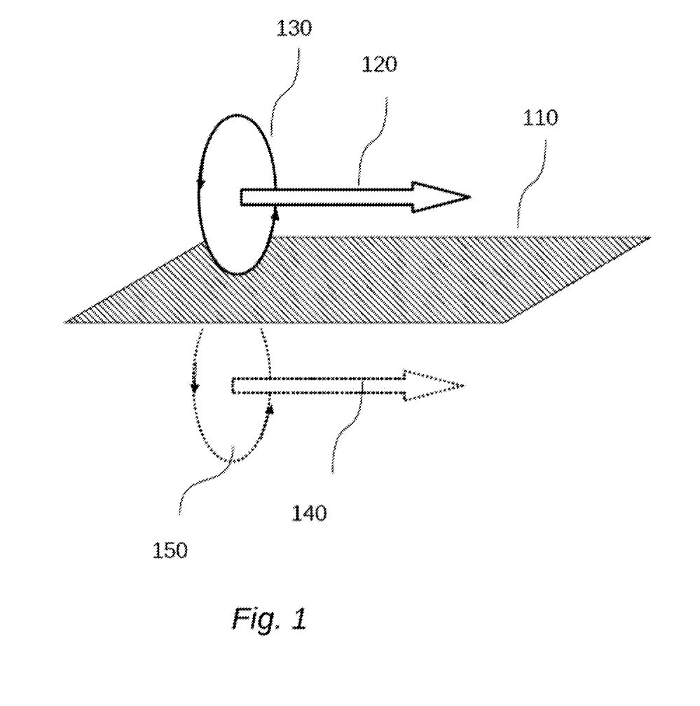

As shown in FIG. 1, a first electric current 120 induces a first circular magnetic field 130 on one side of a near-field PMC 110. The PMC causes an equivalent a second electric current 140 and a second magnetic field 150 on the other side of the PMC.

In contrast with a conventional electrical conductor that generates eddy currents that oppose entry by a magnetic field, the PMC is designed to maximize the entry by the magnetic field.

To a first approximation, the PMC reflects a mirror image of any current-carrying conductor, measurable on the same side of the PMC conductor as the original current. As a side effect, no magnetic field is measureable on the opposite side of the PMC due to the current-carrying conductor. Just as any other reflector, the current 140 and the magnetic field are above the PMC 110.

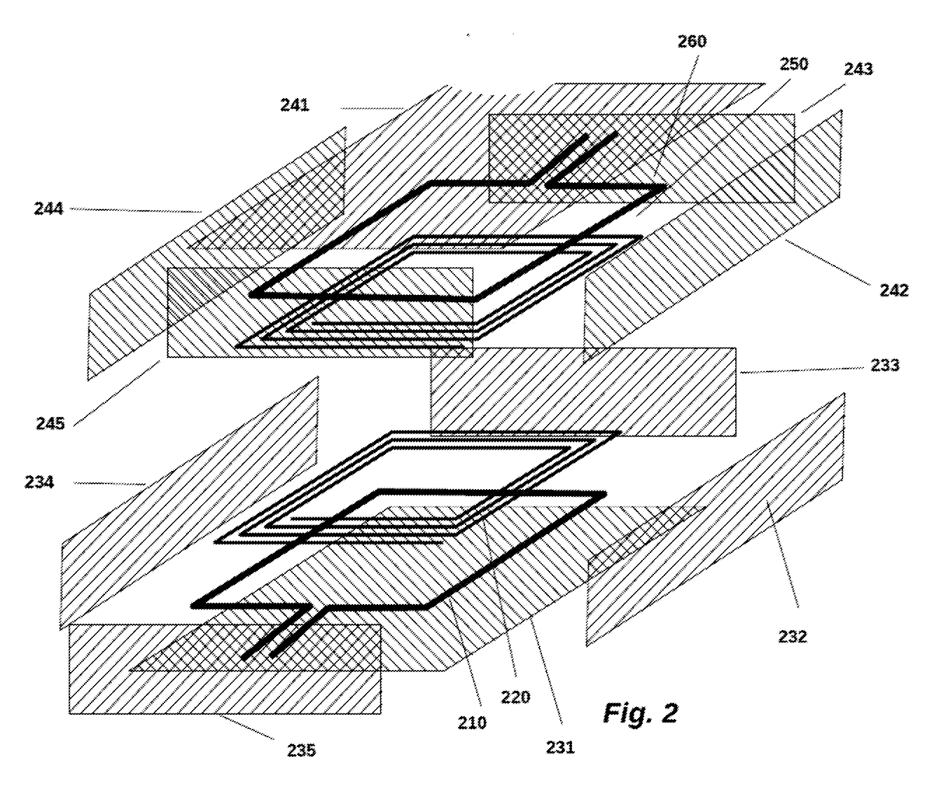

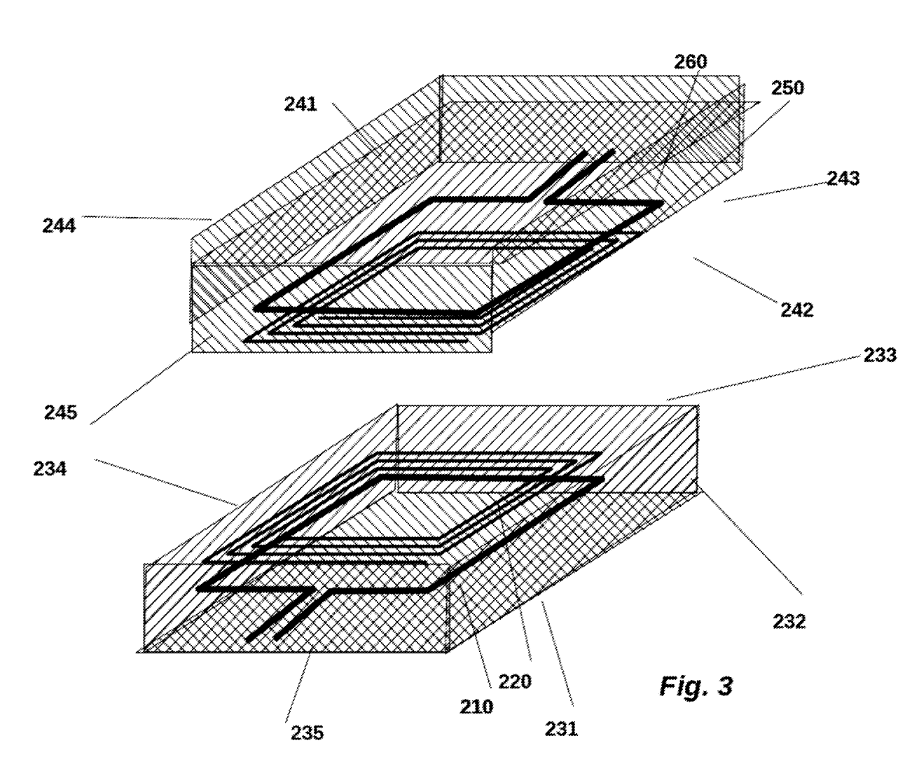

FIGS. 2-3 shows oblique exploded and assembled views, respectively. Here, a wireless energy transmit loop 210 and transmit resonator 220 are arranged in a first PMC housing including a bottom 231 and sides 232, 233, 234, and 235. The wireless energy receiver loop 260 and receiver resonator 250 are arranged in a second housing including a top 241, and sides 242, 243, 244, and 245. The open sides of the housings face each other.

It is understood that during operational use, the transmitter can be connected to a power source while the receiver is connected to a load.

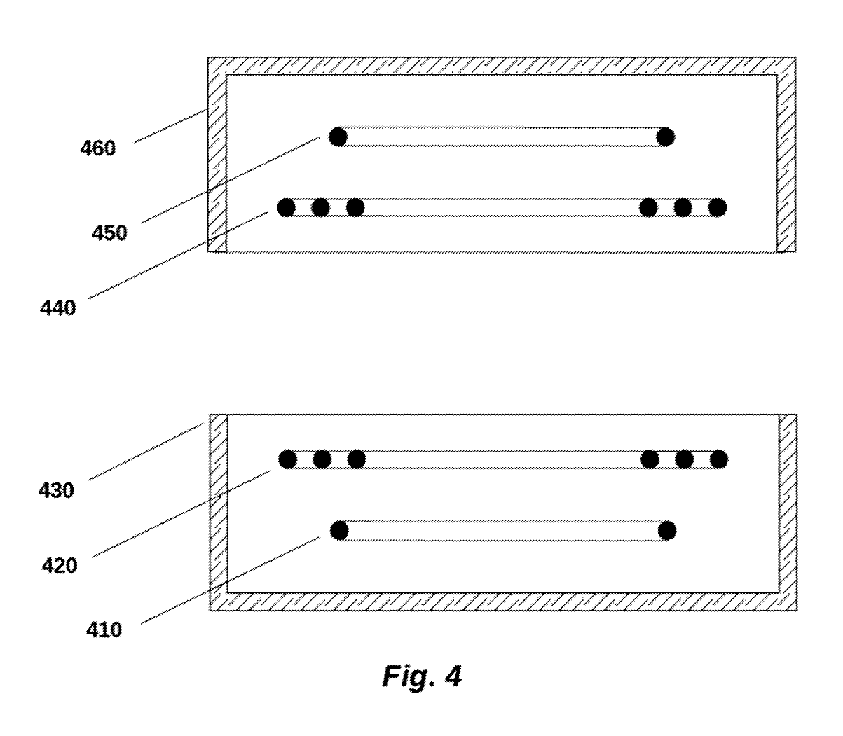

FIG. 4 shows a cross section of the arrangement. A transmit loop 410 and a transmit resonator 420 are partially enclosed in a PMC housing 430, with the open side facing a receive resonator 440 and a receiver loop 450, which are also both partially enclosed by the housing, again with the open sides facing each other.

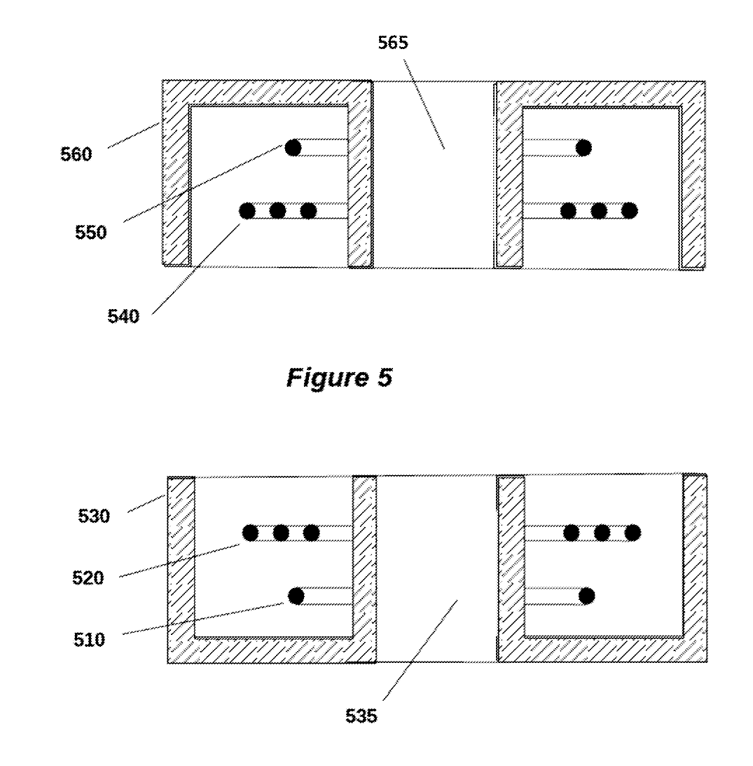

FIG. 5 shows another embodiment with a transmit loop 510 and a transmit resonator 520 arranged in a PMC housing 530. In this embodiment, the PMC housing 530 has a hollow extension of PMC 535 extending within the axis of symmetry to further confine the magnetic field generated by transmit loop antenna 510 and the transmit resonator 520. Similarly, a receive resonator 540 and a receive antenna loop 550 are arranged in a PMC housing 560, again with a hollow extension 565 extending within the axis of symmetry of the receive loop antenna 550 and receive resonator 540. Here, the geometry of the housings are similar to “bundt” baking pans with a hollow core, i.e., hollow half toroids.

The central extensions 535 and 565 improve the efficiency of the wireless energy transfer system.

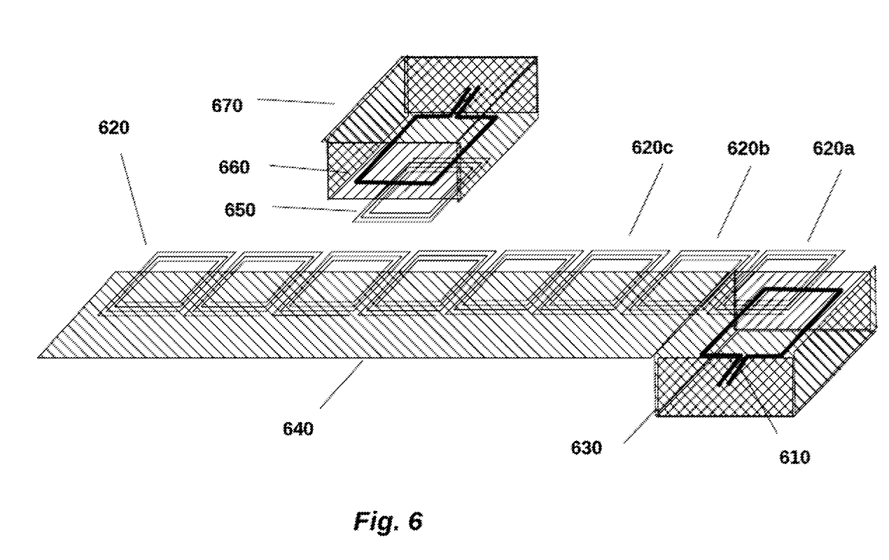

FIG. 6 shows an arrangement using a wireless energy transfer resonator array. As in FIGS. 2-3, the transmit loop antenna 610 is enclosed in an open-sided PMC 630 housing. An array of resonators 620 composed of resonators 620a, 620b, 620c etc. is arranged above the transmit loop antenna 610. An extension of the PMC housing 630 is the underlayment and PMC shield 640. The shield 640 extends beneath the array of resonators 620, and serves two purposes. The shield prevents any losses due to the magnetic field of the array of resonators 620 into an area below the array 620 to effectively double the field strength above the array of resonators 620 by the PMC reflector effect as shown in FIG. 1. Completing the wireless energy transfer system, resonator 650 and receive loop 60 are enclosed in an open-sided PMC housing 670.

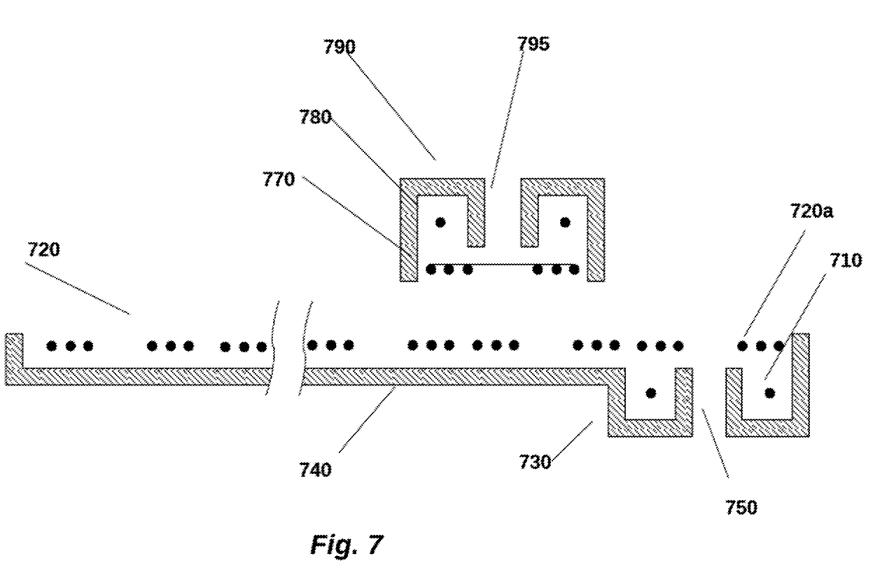

FIG. 7 shows an arrangement for a wireless energy transfer resonator array. A wireless energy transmitter loop 710 and resonator 720a, which is an element of the resonator array 720 are enclosed in an open-sided PMC housing 730. The housing has both an internal extension 750 and extended underlayment 740 to intensify and confine the magnetic field. A receive resonator 770 and receive loop 780 are enclosed in a PMC housing 790, which is also equipped with a hollow internal extension 795, similar to what is shown in FIG. 5. As before, the PMC housing effectively doubles the magnetic field strength, and minimize losses due to straying magnetic fields.

It should be noted that the designations of “transmit” and “receive” loop antennas are entirely arbitrary. In all embodiments, the functionality is identical if the RF energy is applied to the “receive” loop antenna and energy is extracted from the “transmit” loop antenna. Likewise, it is possible to mix and match the use of PMC housings, shields, underlayments, or extensions. Some embodiments do not require the internal PMC extensions such as 535 and 565 in FIG. 5. Some PMC fabrication techniques can use solid rather than hollow extensions. Further, it is not necessary that both the receiver and transmitter both use the PMC. Cost, weight, and other design considerations may dictate that only an underlayment of PMC without a full housing is the most effective design, or that only the transmitter or receiver contains the PMC, or no resonators, instead using only loop antennas and PMC to achieve wireless energy transfer.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A system for transferring energy wirelessly, comprising:
a transmitter of the energy;
a receiver of the energy; and
a housing, wherein the housing is made of a material that approximates properties of a perfect magnetic conductor (PMC), and wherein the housing is arranged to direct a magnetic field from the transmitter to the receiver to improve an efficiency of the energy transfer from the transmitter to the receiver.

2. The system of claim 1, wherein the transmitter comprises a transmit loop. arranged in a first part of the housing, and the receiver comprises a receive loop arranged in a second part of the housing, wherein open sides of the first and second parts of housings face each other.

3. The system of claim 2, wherein geometries of the first and second parts of the housing are hollow half toroids.

4. The system of claim 1, wherein the transmitter comprises a transmit loop and an array of transmit resonators, and the transmit loop is arranged in a first part of the housing, and the receiver comprises a receive loop and a receive resonator, and the transmit loop is arranged in a second part of the housing, wherein open sides of the first and second parts of housings face each other.

5. The system of claim 1, wherein the housing forms a shield around the transmitter and the receiver.

6. The system of claim 1, wherein the housing is an underlayment for the transmitter and the receiver.

7. The system of claim 1, wherein the transmitter comprises a transmit loop and a resonator arranged in a first part of the housing, and the receiver comprises a receive loop and a receive resonator arranged in a second part of the housing, wherein open sides of the first and second parts of housings face each other.
